(19) United States
(12) Patent Application Publication
(10) Pub. No.: US 2019/0263533 A1
(43) Pub. Date: Aug. 29, 2019

(54) SYSTEM FOR THE POWER SUPPLY AND CONTROL OF ELECTRICALLY CONTROLLED ACTUATORS ON BOARD AN AIRCRAFT

(71) Applicant: SAFRAN ELECTRICAL & POWER, Blagnac Cedex (FR)

(72) Inventors: Florent NIERLICH, Blagnac Cedex (FR); Jean-Pierre GARCIA, Blagnac Cedex (FR)

(73) Assignee: SAFRAN ELECTRICAL & POWER,, Blagnac Cedex (FR)

(21) Appl. No.: 16/340,842

(22) PCT Filed: Oct. 11, 2017
(86) PCT No.: PCT/FR2017/052784

§ 371 Date: Apr. 10, 2019

(30) Foreign Application Priority Data
Oct. 13, 2016 (FR) 16 59926

(51) Int. Cl. B64D 41/00; G05B 19/042; H02H 1/00; H02H 7/20

(52) U.S. Cl. CPC B64D 41/00; G05B 19/0423; H02H 1/0007; B64D 2221/00; G05B 2219/25022; G05B 2219/2637; H02H 7/20

(57) ABSTRACT

A power supply and control system of a plurality of electrically controlled actuators on board an aircraft and an actuation system for an aircraft including the electrically controlled actuators and a system for their power supply and their control. The system includes: P electrical power supply units each capable of generating a power signal for powering an actuator, Q control units, each configured for executing at least one servo control algorithm driving a power module of an actuator, and a network communication module connecting each control unit to a computer network for communicating with each actuator.

### TECHNICAL FIELD

The invention lies in the field of the power supply and control of electrically controlled actuators on board an aircraft. It relates in particular to a power supply and control system for the power supply and control of a plurality of electrically operated actuators on board an aircraft and an actuation system for an aircraft including said electrically powered actuators and a system for their power supply and their control.

### PRIOR ART

Aircraft comprise many on-board systems incorporating moving parts requiring setting in motion. These moving parts include wing elements (including ailerons, flaps, air brakes), landing gear elements (e.g. a movable landing gear leg that can take an extended position and a retracted position or a push-rod of a wheel brake which can slide with respect to friction members of the brake), elements for implementing variable turbine geometries, elements of a pump or of a fuel metering mechanism, thrust reverser elements, elements of a drive mechanism of the pitch of a propeller (e.g. on a helicopter or turboprop), etc.

Since the beginning of the 2000s, there has been increasing use of electrically powered and electrically controlled actuators, referred to by the term “electric actuators” for setting these moving parts in motion. Such may notably be the case for primary loads such as the electro-hydraulic generation systems and the starter generator as well as for secondary loads such as the actuators of the flight controls, the thrust reverser, the brakes, the landing gear, etc. The advantages of using electric actuators are manifold. These actuators may indeed be easily integrated into an electrical distribution network by means of simple electrical energy converters. The distribution network may have a relatively moderate complexity and weight and may also have reconfiguration capabilities with the aid of basic (e.g. simple switches) and relatively light electrical components. In addition, maintenance operations may be performed relatively easily, notably compared with hydraulic actuators that require management of the hydraulic fluid.

An electric actuator comprises a movable actuation member suitable for moving the movable part and an electric motor intended for driving the movable actuation member and thus the movable part. In order to be able to power various electric actuators from a single primary power supply line and individually control each electric actuator, an electronic power box must further be interposed between the primary power supply line and each electric actuator. The electronic power box generally comprises a first converter, a control unit and a second converter. The first converter is used for powering the electronic box from the primary power supply network; the control unit is used to generate a control signal for driving the second converter according to a reference signal; and the second converter is used to generate the power supply of the electric motor according to the control signal. Most often, an electric actuator is servo controlled according to one or more parameters related to this actuator. These parameters relate, for example, to the position of the actuation member, a speed of the actuation member, a force exerted thereon, a temperature in the electric actuator and/or the electric current of the power supply line of the electric motor. The electric actuator is then fitted with sensors capable of measuring the various parameters necessary for the servo control and the control unit is configured for implementing a servo control algorithm according to the reference signal and these various parameters. The measured parameters are transmitted to the control unit in the form of a measurement signal. By way of example, the servo control algorithm may implement three nested servo control loops: a position servo control loop, a speed servo control loop and a current servo control loop.

The need to couple each electric actuator with an electronic box leads to the introduction of many components in the power supply and control system of the aircraft. In addition, due to a need for redundancy of the on-board systems, at least two electronic boxes may be introduced per moving part. It follows that the power supply and control system has a significant bulk and mass. Furthermore, each electric actuator is connected to the electronic box by a minimum of eight wires, i.e. at least three wires for conducting the power supply to the motor of the electric actuator and at least four wires for conducting the measurement signal to the control unit of the electronic box. Similarly, when multiple parameters are measured for the servo control, the number of wires required also increases. The wiring of the electric actuators and their power supply boxes may become relatively complex. Further difficulties are added for resolving the electromagnetic compatibility between the various components.

One solution for reducing the number of components required for the power supply and control of a plurality of electric actuators consists in sharing the control units and the second converters of multiple electronic boxes in the same box. However, this solution does not allow reducing the number of necessary connections between such a box and the electric actuators.

The document WO 2010/010251 A2 discloses an electrical power supply system for a set of actuators. The power supply system includes a transformer, delivering a direct current on a power line, a central unit coupled to an external control system generating control signals for the actuators, and a communication interface arranged for exchanging signals with the communication interfaces of the actuators via the power line. The power supply system includes a single central unit generating the control signals. Above all, these control signals are not the result of a servo control algorithm implemented in the central unit. They are reference signals for the servo control performed within an actuator. The document EP 2 842 869 A1 discloses a control system for an aircraft aileron. The control system notably includes a control device comprising a single target current calculation unit and neither does this target current result from a servo control algorithm. The servo control is also achieved within the electric actuator, through its central processing unit. The document US 2007/007385 A1 discloses a control system for the flight control surfaces of an aircraft including a low level control section, a power section and a communication network connecting the elements of these two sections. The low level control section comprises control units generating commands transmitted to the power section. These commands are used by motor control circuits of the power section in order to control the motors.

### DISCLOSURE OF THE INVENTION

The invention thus seeks to provide an architecture for the power supply and control of a plurality of electric actuators that does not have the aforementioned drawbacks. In particular, the invention aims to provide an architecture making it possible to reduce the complexity of the connections between the electric actuators and the components ensuring their power supply and control.

To this end, the invention is based on a new division of the power and control functions and on a sharing of certain functions in a single, preferably reconfigurable, architecture. In particular, the power supply generation function of the various phases of the electric motor is integrated into the electric actuator (the second converter). This is referred to as a smart electric actuator or “smart motor”. The functions of power generation and control signal generation for respectively powering and driving the smart electric actuators are integrated into a new electronic architecture. Data communication between the smart electric actuators and this electronic architecture is performed by a computer network.

More specifically, the subject matter of the invention is a power supply and control system for the power supply and control of a number M of electrically controlled actuators (more simply referred to as “electric actuators” or “actuators”) in an aircraft, with M being a natural integer greater than or equal to two. Each actuator includes:
an electric motor,
a power module arranged for generating a power supply signal of the electric motor from a power signal originating from an electrical power supply unit (PSU) according to a control signal,
measuring means arranged for measuring a servo control value of the actuator and for generating a measurement signal representative of the servo control value, and
a first network communication module connecting the power module and the measuring means to a computer network and configured for transferring the control signal from the computer network to the power module and for transferring the measurement signal from the measuring means to the computer network.

According to the invention, the power supply and control system includes:
a number P of electrical power supply units (PSU), with P a natural integer greater than or equal to one, each electrical power supply unit being capable of generating a power signal for powering the power module of one or more actuators,
a number Q of control units (CMM), with Q a natural integer greater than or equal to one, each control unit being configured for executing at least one servo control algorithm, each servo control algorithm being configured for driving a power module of an actuator by implementing a servo control loop having for a feedback signal the measurement signal of said actuator and for an output signal the control signal intended for said actuator, and
a second network communication module connecting each control unit to the computer network and configured for transferring the measurement signal of each actuator from the computer network to the control unit configured for executing the servo control algorithm driving the corresponding actuator and for transferring over the computer network each control signal intended for an actuator.

The power supply and control system is thus remote from the actuators, communication between these entities being performed by a computer network. The computer network makes it possible to pass through in one direction the measurement signals from the measuring means of the actuators to the control units and, in the other direction, the control signals prepared by the control units to the power modules of the actuators in order to drive them. The servo control of the actuators is not performed locally in each actuator, but remotely in the remote power supply and control system.

Each servo control algorithm, for example, implements one or more nested servo control loops. Typically, a servo control algorithm implements a first, position servo control loop, a second, speed servo control loop and a third, current servo control loop. Each of these loops is implemented remotely from the actuator.

According to a particular feature of the invention, the power supply and control system may comprise, for a single network communication module, a plurality of electrical power supply units (P≥2) and/or a plurality of control units (Q≥2). Preferably, the power supply and control system comprises a plurality (e.g. at least three) of power supply units and/or a plurality (e.g. at least three) of control units.

The same power supply unit may supply power to one or more actuators. Accordingly, the number P of electrical power supply units may be less than the number M of actuators. Furthermore, some electrical power supply units may remain unused in a given installation and/or be provided for redundancy in case of failure. Thus, their number P may be greater than the number M of actuators.

The power supply and control system is preferably integrated in a single box. It thus forms a complete physical entity. The power supply and control system preferably comprises a physical connection interface mounted on the box for connecting the system to all the devices with which it interacts. In particular, the connection interface must comprise a network connector for connecting the second network communication module to the computer network. This is, for example, an RJ45 connector. The connection interface must also comprise an output connector for connecting each electrical power supply unit to power supply cables connected to the power modules of the actuators.

Each power module of an actuator may include at least one switching element. By way of example, each power module comprises an inverter. The power module then comprises at least two switching elements. It comprises, for example, four of them in the case of a single-phase inverter formed by an H bridge. According to a particular embodiment, each servo control algorithm executed by a control unit is then configured for generating the control signal so that it is representative of a duty cycle to be applied to the switching element or, where appropriate, to the switching elements. In other words, the power supply and control system remotely drives each actuator via a control signal representing a duty cycle. Passing through this value has the particular feature of having the whole servo control calculation performed by the control unit of the power supply and control system, while only involving the transmission of a single datum for all the switching elements. In addition, during all the periods during which the electric motor has to be supplied by the same power supply signal, the duty cycle remains unchanged and the power supply and control system therefore has no control signal to be transmitted. The quantity of data to be transmitted is therefore relatively limited. In contrast, a control signal directly driving the opening and closure of the switching elements would require a priori a larger quantity of data to be transmitted, depending on the number of switching elements and especially according to the switching frequency. However, the communication network may be arranged for having a sufficient throughput for directly driving the opening and closure of the switching elements.

Each electrical power supply unit is advantageously arranged for adapting the signal supplied by a primary power supply source to a form of signal that can be used by the power module of an electric actuator. The primary power supply source is preferably common to all the P power supply units. Typically, an aircraft comprises a primary power supply source delivering an AC signal.

At least one of the electrical power supply units may comprise a power converter. Preferably, each of the electrical power supply units comprises a power converter. Each power converter is, for example, a rectifier.

According to a particularly advantageous embodiment, each control unit is arranged for being reconfigurable, so as to be able to execute at least one other servo control algorithm, different from a servo control algorithm for which it was previously configured. Reconfiguring a control unit relates, for example, to the nature of the servo control parameters and/or the parameters of the algorithm relating to the driven actuator.

The power supply and actuation system may further comprise a number P of electrical protection devices, i.e. as many electrical protection devices as there are power supply units. Each electrical protection device is connected to an electrical power supply unit of the system and is intended to be connected to each of the power modules supplied by this electrical power supply unit. It is thus advantageously connected between the electrical power supply unit and an output connector of the power supply and control system. Each electrical protection device is arranged for diagnosing an electrical fault between the electrical power supply unit to which it is connected and the one or more power modules connected thereto, i.e. the one or more power modules supplied by the corresponding electrical power supply unit, and for switching off the power supply in the event of an electrical fault.

An electrical protection device may consist of a simple circuit breaker. It may also be more complex. In particular, the electrical protection device may be arranged for detecting a short circuit, an overvoltage and/or an overload current.

Advantageously, each electrical protection device includes a semiconductor power control unit, known under the term “Solid State Power Controller” or SSPC.

The power supply and control system may then further comprise an internal communication network connecting each protection device to at least one of the control units, each control unit being configured for receiving a status datum from one or more electrical protection devices to which it is connected.

The status datum may notably be representative of the detection of a short circuit, an overvoltage and/or an overload current. A plurality of status data may be generated individually by an electrical protection device, so as to be able to inform the corresponding control unit of the nature of the detected electrical fault.

Advantageously, the internal communication network connects each control unit to each of the P electrical protection devices. Every control unit may thus be associated with every pair formed by an electrical power supply unit and an associated electrical protection device.

According to a particular embodiment, the internal communication network comprises a bus, e.g. a serial bus.

At least one processing unit may be configured for executing at least two servo control algorithms. In this case, the processing unit generates at least two control signals for driving two electric actuators. The number Q of control units may thus be less than the number M of electric actuators. Furthermore, some control units may remain unused in a given installation and/or be provided for redundancy in case of failure. Thus, their number Q may be greater than the number M of electric actuators.

Each control unit may be implemented in a processor, a microprocessor, a microcontroller, an application-specific integrated circuit (ASIC) or a field programmable gate array (FPGA) integrated circuit. Insofar as all the control units are integrated into the same architecture (the same box), the same electronic component may integrate a plurality of, or even all the control units.

In addition, the second network communication module may be integrated in the same electronic component as that integrating one or more processing units.

The subject matter of the invention is also an actuation system for an aircraft including a number M of electrically controlled actuators on board the aircraft and a power supply and control system as previously described. Each actuator includes:
an electric motor,
a power module arranged for generating a power supply signal of the electric motor from a power signal originating from an electrical power supply unit (PSU) according to a control signal,
measuring means arranged for measuring a servo control value of the actuator and for generating a measurement signal representative of the servo control value, and
a first network communication module connecting the power module and the measuring means to a computer network and configured for transferring the control signal from the computer network to the power module and for transferring the measurement signal from the measuring means to the computer network.

Insofar as the actuation system comprises M first network communication modules and a second network communication module, it at least partly integrates the computer network connecting the power supply and control system to the actuators. The computer network could also be fully integrated into the actuation system.

The computer network is based, for example, on an Ethernet protocol.

### BRIEF DESCRIPTION OF THE DRAWINGS

The invention will be better understood with the aid of the following description, given solely by way of a non-restrictive example and referring to the appended drawings, in which:

FIG. 1 schematically represents a distribution architecture according to the prior art for the power supply and control of a set of electrically controlled actuators in an aircraft;

FIG. 2 represents in more detail an electronic box of the distribution architecture represented in FIG. 1;

FIG. 3 represents an embodiment of a load actuation system according to the invention for an aircraft.

### DETAILED DISCLOSURE OF PARTICULAR EMBODIMENTS

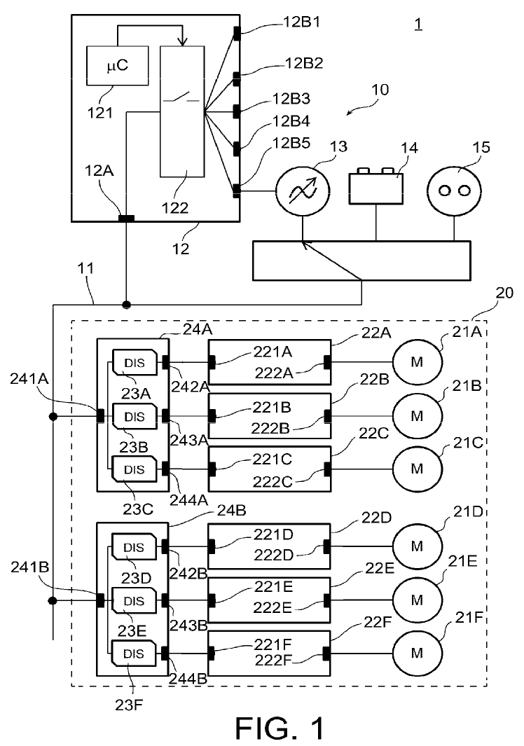

FIG. 1 schematically represents a distribution architecture according to the prior art for powering and controlling a set of electrically controlled actuators in an aircraft. The distribution architecture 1 comprises a primary circuit 10 and a secondary circuit 20.

The primary circuit 10 comprises a primary power supply line 11, a primary box 12, a variable frequency electric generator 13, an electric battery 14, an electrical outlet 15, and a controlled switch 16. The primary box 12 includes an input connector 12A, output connectors 12B1, 12B2, 12B3, 12B4, 12B5, designated globally by the reference 12B, a control unit 121 and a matrix switch 122. The matrix switch 122 is a switch making it possible to connect the input connector 12A to one or more output connectors 12B. The control unit 121 is configured for driving the matrix switch 122 according to commands received by one or more external devices. The input connector 12A is connected to the primary power supply line 11 and each output connector 12B is connected (or is capable of being connected) to a primary load. The variable frequency electric generator 13 thus constitutes a primary load. No other primary load is represented in FIG. 1. A primary load may notably consist of an air conditioning compressor or an electromechanical actuator of the main landing gear. Generally, a primary load refers to an electromechanical device only requiring an intermittent energy input by the primary power supply line 11.

The variable frequency electric generator is used to generate a primary signal capable of supplying power to the whole of the distribution architecture 1. The electric battery 14 is used to store energy in electrochemical form, e.g. for starting the electric generator 13. The electrical outlet 15 is used to connect the primary circuit 10 to a power supply external to the aircraft when the aircraft is parked on the ground. The controlled switch 16 makes it possible to connect to the primary power supply line 11 one of the energy sources selected from the electric generator 13, the electric battery 14 and the electrical outlet 15.

The secondary circuit 20 forms an actuation system for secondary loads of the aircraft. A secondary load designates, for example, an actuator of a flight control, an actuator of a thrust reverser, a braking actuator or an actuator of a nose landing gear. The secondary loads each comprise an electrically controlled actuator 21A, 21B, 21C, 21D, 21E, 21F. The electrically controlled actuators are globally designated by reference 21. Each actuator 21 comprises an electric motor and an actuation member. The actuation member is driven by the movable portion of the electric motor. In order, firstly, to adapt the nature of the primary signal to an appropriate form of signal for each actuator 21 and, secondly, to individually control the actuators 21 according to dedicated reference signals, each actuator is connected to the primary power supply line 11 via an electronic control box 22A, 22B, 22C, 22D, 22E, 22F. The electronic control boxes are globally designated by reference 22. Each electronic box 22 comprises an input connector 221A-221F and an output connector 222A-222F. An electronic box 22 generally only powers and controls a single actuator 21, or else a plurality of actuators operating identically. Indeed, each electronic box 22 is arranged for only delivering a single set of signals for driving an electric motor, namely a single signal for a single-phase motor or three signals for a three-phase motor. In addition, in order to protect, in the event of an electrical fault of an electronic control box or of an actuator 21, the rest of the secondary circuit 20, the electronic control boxes 22 are connected to the primary power supply line 11 via circuit breakers 23A, 23B, 23C, 23D, 23E, 23F. The circuit breakers are globally designated by reference 23. The circuit breakers 23 are grouped within secondary boxes 24A, 24B, globally designated by reference 24. In the example in FIG. 1, the secondary box 24A integrates the circuit breakers 23A, 23B and 23C and the secondary box 24B integrates the circuit breakers 23D, 23E and 23F. Each secondary box 24 comprises an input connector 241A-241B and an output connector 242A-244A, 242B-244B for each circuit breaker 23. Each circuit breaker 23 is connected between an input connector 241A, 241B and one of the output connectors 242A-244A, 242B-244B. The input connectors 241A, 241B are each connected to the primary power supply line 11. The input connector 221A-221F of each electronic box 22A-22F is connected to one of the output connectors 242A-244A, 242B-244B of the secondary boxes 24. Each output connector 222A-222F is connected to an actuator 21.

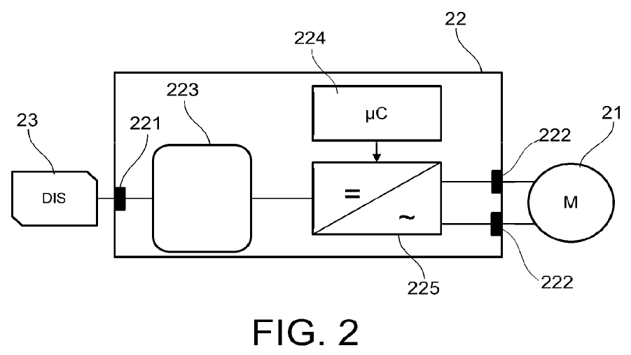

FIG. 2 schematically represents a detail of an embodiment of the secondary circuit 20 in FIG. 1. In particular, it details in functional form the composition of an electronic box 22 and its input and output connection. The electronic box 22 comprises, in addition to the input connector 221 and the output connector 222, a first converter 223, a control unit 224 and a second converter 225. The first converter 223 is connected at the input to the input connector 221 and at the output to an input of the second converter 225. The second converter 225 is connected at the output to the output connector 222. The first converter 223 has the function of powering the entire electronic box 22. In particular it is used to supply a power signal to the second converter 225. The primary signal supplied by the primary power supply line 11 is generally an AC signal. The first converter 223 then acts as a rectifier. The electric motor of the actuator 21 is generally powered by an AC power supply signal. The second converter 225 then acts as an inverter. In addition, in order to be able to control a rotational speed of the electric motor, the second converter 225 is controlled by the control unit 224. The control unit receives a reference signal and drives switching elements of the second converter 225. The motor is generally controlled by pulse width modulation.

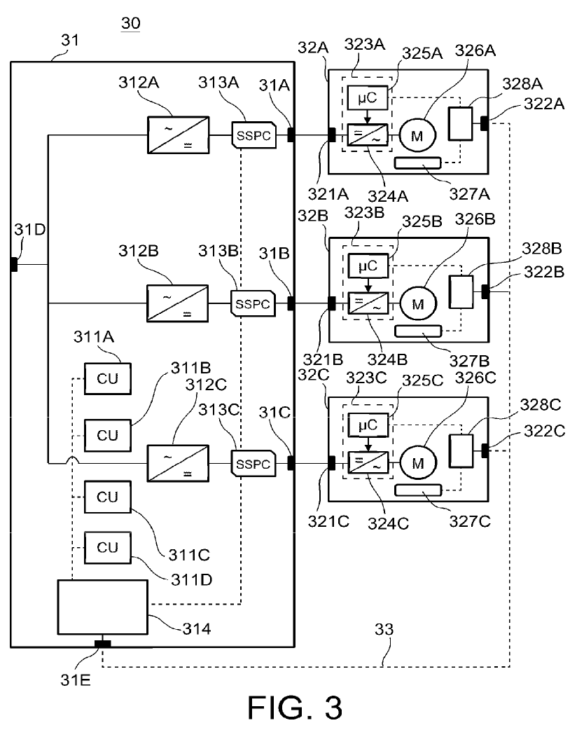

FIG. 3 represents an embodiment of a secondary circuit according to the invention. The secondary circuit 30 forms an actuation system for secondary loads of an aircraft. The secondary circuit 30 comprises a power supply and control system 31, three electrically controlled actuators 32A, 32B, 32C, and a transmission line 33.

The power supply and control system 31 is advantageously integrated in a single box. It may also be called a secondary box, insofar as it is also intended to be connected between the primary power supply line 11 and the electric actuators. However, this secondary box 31 is clearly differentiated from the secondary boxes 24 in FIG. 1. The power supply and control system 31 comprises three output connectors 31A, 31B, 31C, an input connector 31D and a network connector 31E. The input connector 31D is intended to be connected to the primary power supply line 11. The power supply and control system 31 further comprises four control units 311A, 311B, 311C, 311D, three electrical power supply units 312A, 312B, 312C, three electrical protection devices 313A, 313B, 313C and a network communication module 314. More generally, a power supply and control system 31 according to the invention may comprise a number P of electrical power supply units 312, electrical protection devices 313 and output connectors 31, and a number Q of control units 311. The numbers P and Q may be the same or different. They are, for example, between three and twelve. Each control unit 311 is network connected to the network communication module 314. Each electrical power supply unit 312 is connected at the input to the input connector 31D and at the output to an input of one of the electrical protection devices 313. Each electrical protection device 313 is connected at the output to one of the output connectors 31A, 31B, 31C. In addition, each electrical protection device 313 is network connected to the network communication module 314.

Each electrical power supply unit 312 is capable of generating a power signal for powering the power module of one or more electrically controlled actuators 32. In this case, the electrical power supply units 312A, 312B, 312C are each capable of generating a power signal for one of the electrically controlled actuators 32A, 32B, 32C, respectively. Each electrical power supply unit 312 comprises, for example, a rectifier, so as to deliver a DC power signal.

Each electrical protection device 313 is arranged for diagnosing an electrical fault between the electrical power supply unit 312 to which it is connected and the one or more power modules connected thereto and for switching off the power supply in the event of an electrical fault. In other words, the electrical protection devices 313 make it possible to isolate the electrically operated actuators 32 from the primary power supply line 11. Advantageously, the electrical protection devices 313 are constituted by semiconductor power control units, referred to as “Solid State Power Controllers”. The electrical protection devices 313 may be connected to the control units 311 in order to transfer one or more status data thereto, representative of a status of the electrical protection devices. The connection between the electrical protection devices 313 and the control units 311 may be based on the network formed between the control units 311 and the electrically controlled actuator 32 or be achieved by independent communication means. In the latter case, the connection may be achieved by means of a serial bus.

Each control unit 311 is configured for executing at least one servo control algorithm, each servo control algorithm being configured for driving a power module 324A, 324B, 324C of an electric actuator 32A, 32B, 32C by implementing a servo control loop having for a feedback signal a measurement signal of this actuator 32 and for an output signal a control signal intended for this actuator 32. The servo control algorithm may implement a single servo control loop or a plurality of nested servo control loops. By way of example, a servo control algorithm may implement a first, position servo control loop, a second, speed servo control loop and a third, current servo control loop. Each servo control algorithm is executed by taking into consideration a reference signal received from an external control unit via the network communication module 314. According to a particular feature of the invention, each control unit 311 does not directly drive the switching elements of a power module 324, but generates a control signal for driving them indirectly, via a drive unit 325 internal to the electric actuator 32. Preferably, this control signal is representative of a duty cycle to be applied by the switching elements. Thus, even when a plurality of switching elements has to be driven non-simultaneously, the same control signal is generally used to control them. Such is notably the case when the switching elements are driven with a phase shift, e.g. in a three-phase inverter. According to its processing capacities, each control unit may execute one or more servo control algorithms, i.e. for one or more electrically controlled actuators 32. It should be noted that the control units 311 and the electrical power supply units 312 are completely decoupled from each other. In particular, each control unit 311 may drive an actuator 32 powered by any electrical power supply unit 312. It may also drive electrically controlled actuators 32 powered by different electrical power supply units 312. A control unit is, for example, implemented in software form in a processor or in a microcontroller. Preferably, it is reconfigurable, so as to be able to execute a different servo control algorithm. It may then drive the same actuator or another actuator differently.

The network communication module 314 makes it possible to connect each control unit 311 and each electrical protection device 313 to a computer network. In particular, it is configured for transferring over the computer network each control signal intended for an electric actuator 32. It is also configured for transferring a measurement signal originating from an actuator 32 to the control unit configured for executing the servo control algorithm driving this actuator 32. The network communication module 314 may also be configured for ensuring data communication between the control units 311 and the electrical protection devices 313. These data concern, for example, the status data of the electrical protection devices 313. The network communication module 314 comprises, for example, a network switch or a router. Generally, the network must allow each control unit 311, each actuator 32 and, where appropriate, each electrical protection device 313 to be addressed individually.

Each actuator 32 comprises a power connector 321, a data connector 322, a power module 323 including a power converter 324 and a drive unit 325, an electric motor 326, measuring means 327 and a network communication module 328. Preferably, the power connector 321, the data connector 322, the power module 323, the electric motor 326, the measuring means 327 and the network communication module 328 are integrated in the body of the actuator 32. The power connector 322 is intended to be connected to one of the output connectors 31A, 31B, 31C. The power converter 324 is connected at the input to the power connector 321 and at the output to the electric motor 326. The drive unit 325 is connected to the power converter 324 for driving its switching elements according to a control signal received from a control unit 311. The network communication module 328 makes it possible to connect the drive unit 325 and the measuring means of each actuator to the computer network via the data connector 322. In particular, it is configured for transferring the appropriate control signal from the control unit 311 to the drive unit 325 and for transferring a measurement signal generated by the measuring means 327 to this same control unit 311.

The measuring means 327 of each actuator 32 are used to measure one or more servo control values associated with the actuator 32 in question and to generate a signal representative of these servo control values. This representative signal is then used by a control unit 311 for executing a servo control algorithm driving the actuator. The measuring means, for example, comprise an ammeter, a position sensor and/or a temperature sensor.

The power converter 324 of each actuator 32 is arranged for transforming the power signal delivered by an output connector 31A, 31B, 31C into a power supply signal capable of powering the electric motor 326 according to a control signal. When the power signal is a DC signal and the electric motor is an AC motor, the power converter 324 is then an inverter.

The drive unit 325 of each actuator 32 is arranged for driving the switching elements of the power converter 324. It receives the control signal comprising, for example, a datum representative of a duty cycle, and determines the switching instants of each of the switching elements. Thus, the power converter 324 is, as it were, driven in two steps, a first step being performed at the level of a control unit 311 and a second step being performed in the drive unit 325.

The network communication module 328 of each actuator 32 is configured for being able to communicate with the network communication module 314 of the power supply and control system 31. Generally, the network must allow each drive unit 325 and each of the measuring means 327 to be addressed individually. It must allow the exchange of data between each control unit 311, each drive unit 325 and each of the measuring means 327. The network is based, for example, on an Ethernet protocol. Of course, other protocols may be used. The transmission line 33 is suited to the protocol used.

1-11. (canceled)

12. A remote power supply and control system for the power supply and control of a number M of electrically controlled actuators in an aircraft, with M a natural integer greater than or equal to two, the remote power supply and control system being connected to the actuators by a computer network, each actuator comprising:
an electric motor,
a power module arranged for generating a power supply signal of the electric motor from a power signal originating from an electrical power supply unit according to a control signal,
measuring means arranged for measuring a servo control value of the actuator and for generating a measurement signal representative of the servo control value, and
a first network communication module connecting the power module and the measuring means to the computer network and configured for transferring the control signal received via the computer network to the power module and for transferring the measurement signal from the measuring means to the computer network,
the remote power supply and control system including:
a number P of electrical power supply units, with P a natural integer greater than or equal to two, each electrical power supply unit being capable of generating a power signal for powering the power module of one or more actuators,
a number Q of control units, with Q a natural integer greater than or equal to two, each control unit being configured for executing at least one servo control algorithm, each servo control algorithm being configured for remotely driving a power module of an actuator by implementing a servo control loop having for a feedback signal the measurement signal of said actuator and for an output signal the control signal intended for said actuator, and
a second network communication module connecting each control unit to the computer network and configured for transferring the measurement signal of each actuator received via the computer network to the control unit configured for executing the servo control algorithm driving the corresponding actuator and for transferring over the computer network each control signal intended for an actuator.

13. The system of claim 12, wherein each power module of an actuator including at least one switching element, each servo control algorithm executed by a control unit is configured for generating the control signal so that it is representative of a duty cycle to be applied to the switching element.

14. The system of claim 12, wherein at least one of the electrical power supply units comprises a power converter.

15. The system of claim 12, wherein each control unit is arranged for being reconfigurable, so as to be able to execute at least one other servo control algorithm, different from a servo control algorithm for which it was previously configured.

16. The system of claim 12, wherein the second communication module is arranged for being able to be reconfigured, so as to modify the control unit to which the measuring signal is transferred from an actuator.

17. The system of claim 12, further including a number P of electrical protection devices, each electrical protection device being connected to an electrical power supply unit of the system and being intended to be connected to each of the power modules powered by said electrical power supply unit, each electrical protection device being arranged for diagnosing an electrical fault between the electrical power supply unit to which it is connected and the one or more power modules that are connected thereto and for switching off the power supply in the event of an electrical fault.

18. The system of claim 17, wherein each electrical protection device comprises a semi-conductor power control unit.

19. The system of claim 17, further including an internal communication network connecting each electrical protection device to at least one of the control units, each control unit being configured for receiving a status datum from one or more electrical protection devices to which it is connected.

20. The system of claim 12, wherein at least one control unit is configured for executing at least two servo control algorithms.

21. An actuation system for an aircraft including a number M of electrically controlled actuators on board the aircraft and the remote power supply and control system of claim 12, the remote power supply and control system being connected to the actuators by a computer network, each actuator comprising:
an electric motor,
a power module arranged for generating a power supply signal of the electric motor from a power signal originating from an electrical power supply unit according to a control signal,
measuring means arranged for measuring a servo control value of the actuator and for generating a measurement signal representative of the servo control value, and
a first network communication module connecting the power module and the measuring means to the computer network and configured for transferring the control signal received via the computer network to the power module and for transferring the measurement signal from the measuring means to the computer network.

22. The actuation system of claim 21, wherein the computer network is based on an Ethernet protocol.
